(19) United States
(12) Patent Application Publication
(10) Pub. No.: US 2005/0086104 A1
(43) Pub. Date: Apr. 21, 2005

(54) Delivery of advertising to telephone users

(76) Inventor: Jeffrey A. McFadden, Hillsborough, CA (US)

Correspondence Address: OKAMOTO & BENEDICTO, LLP, P.O. BOX 641330, SAN JOSE, CA, 95164, US

(21) Appl. No.: 10/725,192

(22) Filed: Dec. 1, 2003

Related U.S. Application Data
(60) Provisional application No. 60/512,674, filed on Oct. 17, 2003.

(51) Int. Cl. G06F 17/60

(52) U.S. Cl. 705/14

(57) ABSTRACT

In one embodiment, advertisements are delivered to a telephone user by detecting an interest by a user in a destination telephone number, determining a category of the destination telephone number, and providing the user an advertisement based on the category of the destination telephone number. For example, a call by a user to a destination telephone number may be detected. A database may then be consulted to determine if the destination telephone number belongs to a particular category of businesses (e.g., restaurant, movie theater, air line, . . . ). If so, advertisements for similar businesses may be provided to the telephone user. Among other advantages, this allows for delivery of relevant advertisements to telephone users.

### CROSS-REFERENCE TO RELATED APPLICATION

This application claims the benefit of U.S. Provisional Application Ser. No. 60/512,674, entitled “DELIVERY OF ADVERTISING TO TELEPHONE USERS”, filed by Jeffrey A. McFadden on Oct. 17, 2003, which is hereby incorporated by reference in its entirety.

### BACKGROUND OF THE INVENTION

1. Field of the Invention

The present invention relates generally to telephone networks, and more particularly but not exclusively to techniques for delivering messages to telephone users.

2. Description of the Background Art

Advances in electronics technology allow telephone equipment manufacturers to incorporate sophisticated features in telephones and associated systems in telephone networks. As a result, modern telephones have computing capability and memory capacity that were previously available only on small computers. Despite these technological advancements, advertisement delivery to telephone users remains relatively ineffective. More specifically, conventional techniques for delivering advertisements to telephone users are mostly untargeted in that the advertisements are not optimized to be relevant to a user's interests. At most, these advertisements are solely based on user-supplied demographics information, which may be inaccurate or incomplete, or the user's present location, which may have no bearing on the user's current interests. Because advertisements have the potential to improve and lower the cost of telephone services by providing telephone companies an additional source of revenue, an improved technique for delivering advertisements to telephone users is highly desirable.

### SUMMARY

In one embodiment, advertisements are delivered to a telephone user by detecting an interest by a user in a destination telephone number, determining a category of the destination telephone number, and providing the user an advertisement based on the category of the destination telephone number. For example, a call by a user to a destination telephone number may be detected. A database may then be consulted to determine if the destination telephone number belongs to a particular category of businesses (e.g., restaurant, movie theater, air line, . . . ). If so, advertisements for similar businesses may be provided to the telephone user. Among other advantages, this allows for delivery of relevant advertisements to telephone users.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 schematically shows an example telephone network where embodiments of the present invention may be employed.

FIG. 2 shows a flow diagram of a method for delivering advertisements to telephone users in accordance with an embodiment of the present invention.

FIG. 3 shows a flow diagram of a method for delivering advertisements to telephone users in accordance with an embodiment of the present invention.

FIG. 4 schematically shows how advertisements may be displayed on a display of a telephone.

FIG. 5 shows an example pop-up window in accordance with an embodiment of the present invention.

The use of the same reference label in different drawings indicates the same or like components.

### DETAILED DESCRIPTION

In the present disclosure, numerous specific details are provided such as examples of apparatus, components, and methods to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

Methods in the present disclosure, may be implemented in hardware, software, or a combination of hardware and software (e.g., firmware). As is well known, software implementations may be in the form of computer-readable program code stored in a computer-readable storage medium, such as memory or another storage device. For example, a computer-readable storage medium may comprise computer-readable program code for performing a method. Likewise, computer memory may be configured to include the steps of a method, which may then be run by a processor.

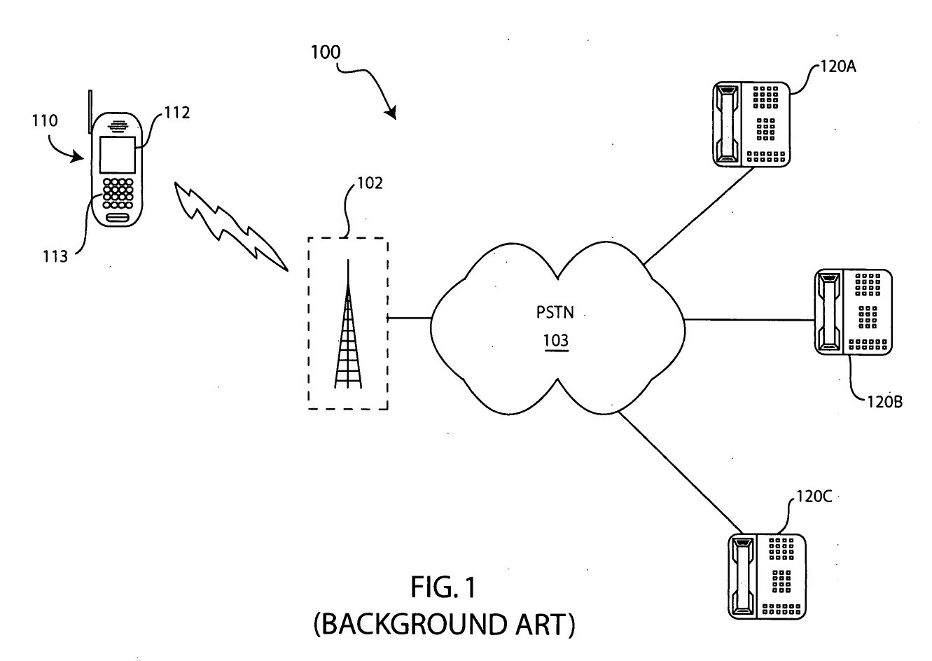

FIG. 1 schematically shows an example telephone network 100 where embodiments of the present invention may be employed. Network 100 includes a public switched telephone network (PSTN) 103 and a wireless infrastructure 102 for connecting a telephone 110 to any of telephones 120 (i.e., 120A, 120B, . . . ) and vice versa. Other telephone network components, such as circuit switches, are not shown in the interest of clarity.

In network 100, telephone 110 is depicted as a wireless mobile telephone coupled to PSTN 103 via infrastructure 102. Telephone 102 may also be a wired telephone coupled to PSTN 103 via land lines, for example. Telephone 102 may include a display 112 and a keypad 113. Not shown are the internal components of telephone 102, such as a processor and memory. Telephone 102 may have multi-media capability to allow it to run a web browser to connect it to the Internet, play a video game, run personal digital assistant programs (e.g., calendar, contact list), display a map, take and transmit a digital picture, and the like.

Telephones 120 are depicted as wired telephones coupled to PSTN 103 via land lines. Telephones 120 may also be wireless telephones depending on the application. In the present disclosure, each of telephones 120 represents a telephone of a business establishment. For example, telephone 120A may be that of a restaurant. A user may thus employ telephone 110 to call telephone 120A to make a reservation or get directions to the restaurant.

Wireless infrastructure 102 may be operated by a wireless telephone company, while all or portions of PSTN 103 may be operated by a local or long distance telephone company. Unless otherwise stated, the term “telephone company” is employed in the present disclosure to refer to a single telephone company, combination of telephone companies, or one or more service providers in a telephone network. In the example of telephone network 100, a telephone company may be the wireless telephone company providing service to telephone 110, the telephone company providing service to telephones 120, another telephone company providing service in network 100, or any combination of telephone companies providing services in network 100. The telephone company operating wireless infrastructure 102 may generate revenue by delivering advertisements to telephone 110. As another example, the telephone company operating wireless infrastructure 102 may share revenues with another telephone company providing service in network 100 or with a provider of a telephone 110 by cooperatively delivering advertisements to telephone 110; together, the aforementioned telephone companies may also be a “telephone company” for purposes of the present disclosure.

A telephone company does not necessarily have to be an operator of a POTS (plain old telephone service) infrastructure. For example, a telephone company may simply provide a telephone 110 free of charge or at some discounted price in exchange for the right to deliver advertising to the telephone 110, by uploading advertisements to telephone 110 via telephone network 100 from time to time, for example. Note that for purposes of the present disclosure, the term “advertisement” is not limited to those relating to the marketing and sale of products (i.e., goods and services). An advertisement may include any paid message. A political campaign is an example of a non-product-related advertisement.

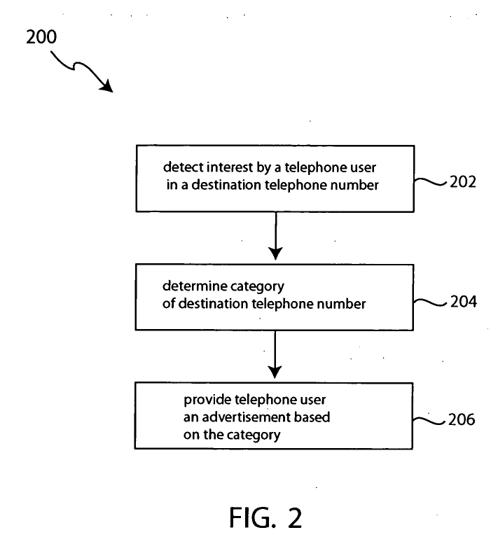

FIG. 2 shows a flow diagram of a method 200 for delivering advertisements to telephone users in accordance with an embodiment of the present invention. Method 200 may be performed by a piece of software running in a telephone 110 or in one or more computers coupled to telephone network 100.

In step 202, the interest by a telephone user in a destination telephone number is detected. Step 202 may be performed by detecting when a user employs telephone 110 to call the number (“destination telephone number”) of a telephone 120.

In step 204, a category of the destination telephone number is determined. Step 204 may be performed by consulting a database of telephone numbers along with their respective categories. Telephones 120 may be categorized according to the business of their respective owners. For example, the telephone numbers of restaurants may be in a “restaurant category,” the telephone numbers of hotels may be in a “hotel category,” the telephone numbers of movie theaters may be in a “movie theater category,” and so on.

In step 206, the telephone user is provided an advertisement based on the category of the destination telephone number. The advertisement may be pre-stored in telephone 110 or pulled upon demand from a content server coupled to telephone network 100. For example, if the telephone user dialed the number of a restaurant, the telephone user is provided an advertisement for other restaurants. The advertisement may be provided to the user before or after she completes the call to the restaurant. The advertisement may also be provided to the user during the call, by displaying the advertisement in display 112, for example.

In light of the present disclosure, those of ordinary skill in the art will appreciate that the present invention provides advantages heretofore unrealized. A call to a destination telephone number is an express manifestation of a user interest. Therefore, the user is more likely to respond to advertisements that relate to that destination telephone number. Providing the advertisement at a time when the user is actually thinking of the product associated with the destination telephone number further increases the chance that the user will respond to the advertisement.

Unlike embodiments of the present invention,,which allow for delivery of targeted and relevant advertisements, conventional telephone advertisement delivery techniques are either untargeted or rely solely on user-supplied demographics information. While demographics information provides valuable data for targeting purposes, it would be more effective if supplemented with other information. In embodiments of the present invention, demographics information may be employed along with user behavioral information (e.g., favorite destination telephone numbers, calling habits) to select the most relevant advertisement for the user.

The teachings of the present disclosure may be extended to improve the advertisement process selection over time. That is, behavioral information of the telephone user may be compiled and then later used to determine the most relevant advertisement for the user. For example, if the user's calling pattern suggests that the user calls a movie theater to check show times on Friday nights, advertisements for movies may be delivered to the user on Thursdays. Also, users who regularly calls restaurants (e.g., to make reservations) may be interested in advertisements for credit cards providing entertainment discounts, for example.

The contents of an example database in accordance with an embodiment of the present invention are now described with reference to Table 1. As can be appreciated, a database may be configured to set the cells of Table 1 as searchable fields. The size of the database (and the number of entries in it) may be limited by the medium in which it is stored. For example, the database may be relatively small and contain less entries when stored in a telephone 110 rather than in a server computer coupled to telephone network 100.

TABLE 1

| Business | | Sub- | Sub- | |
|---|---|---|---|---|
| Estab- | Main | Category | Category | Telephone |
| lishments | Category | (Type) | (Location) | Number |
| Joe's | Restaurant | Sea Food | San Jose, CA | (408)555-2345 |
| Seafood | | | | |
| Cuisine | | | | |
| Blue Lobster | Restaurant | Sea Food | San Jose, CA | (408)555-3456 |
| Big Burger | Restaurant | Fast Food | San Jose, CA | (408)555-4567 |
| Tomato | Restaurant | Italian | San Jose, CA | (408)555-5678 |
| Gardens | | | | |
| Fish | Restaurant | Sea Food | Palo Alto, CA | (650)555-1212 |
| Marketer | | | | |
| Marina Sea | Restaurant | Sea Food | San Jose, CA | (408)555-1212 |
| Food | | | | |
| Admiral's | Restaurant | Sea Food | San Jose, CA | (408)123-1234 |
| Feast | | | | |
| Triangle Air | Air Line | International | | (800)555-1212 |
| Lines | | | | |
| United | Air Line | Domestic | | (800)555-1234 |
| Airways | | | | |
| Pan Flights | Air Line | International | | (800)555-2345 |
| Chevy Guys | Dealership | Chevy | San Jose, CA | (408)556-6789 |
| Books R' Us | Bookstore | default | Oakland, CA | (510)444-5555 |
| etc. | | | | |

As shown in Table 1, the telephone numbers of business establishments may be categorized according to their respective products. In the example of Table 1, restaurant establishments are categorized under “restaurants.” To fine tune the targeting (i.e., selection of relevant advertisement), business establishments may be further sub-categorized according to specialty. For example, restaurants that specialize in sea foods may be sub-categorized under “sea food.” Additional sub-categories may be added to further tune the targeting. For example, each business establishment may be sub-categorized by “location” to allow for filtering of businesses in a particular location. In the restaurant example, a call to Joe's Seafood Cuisine located in San Jose, Calif. preferably triggers delivery of advertisements for restaurants that are also located in San Jose, Calif.

The database may also have a “default” sub-category to allow for delivery of advertisements that do not fit any of the categories of the destination telephone number. Furthermore, a business establishment may belong to several categories. For example, Joe's Seafood Cuisine may belong in the category “restaurant” and also in a category “entertainment” (not shown in Table 1).

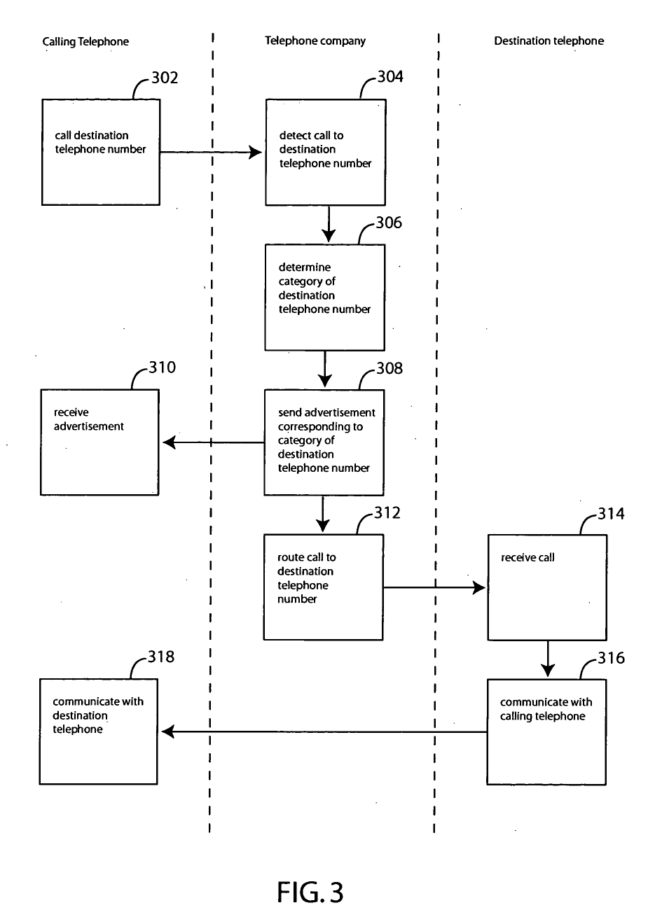

Referring to FIG. 3, there is shown a flow diagram of a method for delivering advertisements to telephone users in accordance with an embodiment of the present invention. FIG. 3 is divided according to the steps performed using a calling telephone, steps performed by the systems of a telephone company, and steps performed using a destination telephone. As mentioned, the “telephone company” does not necessarily have to be an operator of a POTS infrastructure. Thus, in the example of FIG. 3, the steps performed by the “telephone company” may be performed by any service provider in telephone network 100 or by a combination of companies providing services in telephone network 100. For example, steps 304, 306, and 308 may be performed by a service provider that provides a telephone 110 with monitoring software and operates an advertising server coupled to telephone network 100, while step 312 may be performed by a POTS company. The telephone advertisement delivery techniques disclosed herein may be performed by any service provider using any suitable hardware and software without detracting from the merits of the present invention.

In step 302, the calling telephone (e.g., a telephone 110) is employed to call a destination telephone number (e.g., that of a telephone 120).

In step 304, a system of the telephone company detects the call to the destination telephone number.

In step 306, a category of the destination telephone number is determined. Step 306 may be performed by searching a database (e.g., see Table 1).

In step 308, an advertisement corresponding to the category of the destination telephone number is sent to the calling telephone. Advertisements may be stored in a content server operated by the telephone company, and pulled for delivery to the calling telephone. Each advertisement may be stored with tags indicating its categories. For example, an advertisement for a sea food restaurant may have the tags “restaurant”, “sea food”, and ”San Jose, Calif.” This allows for retrieval of all relevant advertisements for a destination telephone number in the categories “restaurant”, “sea food”, and/or “San Jose, Calif.” The telephone company may also rank the advertisements according to the amounts their respective advertisers paid to have the advertisements delivered. Higher ranked advertisements may have delivery priority over lower ranked advertisements. For example, if only four advertisements may be delivered to the calling telephone and there are twenty relevant advertisements, the four highest ranked advertisements among the twenty relevant advertisements may be delivered. Among the four advertisements delivered to the calling telephone, the highest ranked advertisement may be placed on top of display 112, followed by the second highest ranked advertisement, and so on. The ranking may be specified in a tag stored with each advertisement in the content server. The telephone company may specify a fixed fee for each rank in each category, or may have advertisers bid for the ranking. The telephone company may charge an advertiser for each delivered advertisement or per call-through (i.e., the user actually calling the telephone number of the advertiser), for example. In light of the present invention, those of ordinary skill in the art will appreciate that other techniques for charging advertisers to have their advertisements delivered may be employed without detracting from the merits of the present invention.

In step 310, the calling telephone receives the advertisement.

In step 312, the call made by the calling telephone is routed to the destination telephone number. In the example of FIG. 3, the advertisement is delivered to the calling telephone before the call is routed. Depending on the application, the advertisement may also be delivered after or during the call (e.g., advertisements without audio).

In step 314, the destination telephone receives the call from the calling telephone.

In steps 316 and 318, users of the calling and destination telephones proceed to communicate.

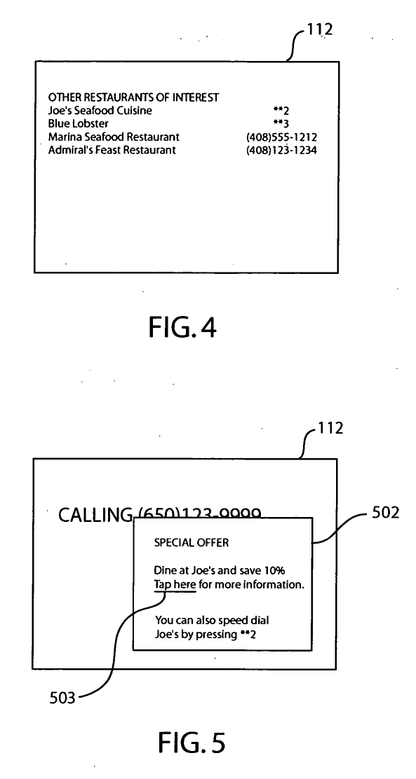

FIG. 4 schematically shows how advertisements may be displayed on display 112 of telephone 110. In the example of FIG. 4, the user dialed the telephone number of a sea food restaurant, and accordingly received advertisements for other restaurants. As shown in FIG. 4, each advertisement may be accompanied by a telephone number, or a speed dial number (e.g., **2 to call Joe's Sea Food Cuisine) to facilitate a call to the advertised business.

Depending on the telephone employed by the user, advertisements may also take advantage of graphical interfaces. FIG. 5. shows an example pop-up window 502 displaying an advertisement for Joe's Sea Food Cuisine. Window 502 includes a hyperlink 503 that may be tapped to call the advertised business, or to receive maps and coupons, for example. Other presentation vehicles may also be employed to display advertisements without detracting from the merit of the present invention.

While specific embodiments of the present invention have been provided, it is to be understood that these embodiments are for illustration purposes and not limiting. Many additional embodiments will be apparent to persons of ordinary skill in the art reading this disclosure.

1. A method of delivering advertising to a telephone user, the method comprising:
detecting an interest by a user in a destination telephone number;
determining a category of the destination telephone number; and
providing the user an advertisement based on the category of the destination telephone number.

2. The method of claim 1 wherein the user manifests the interest in the destination number by calling the destination telephone number.

3. The method of claim 1 wherein the advertisement is delivered to a mobile phone employed by the user.

4. The method of claim 1 wherein the advertisement is shown on a display of a telephone employed by the user.

5. The method of claim 1 wherein the advertisement is shown as a pop-up window on a display of a telephone employed by the user.

6. The method of claim 1 wherein the advertisement and the destination telephone number belong to different business establishments providing similar or related products.

7. The method of claim 1 wherein the advertisement is from an advertiser who pays the most among advertisers in the category.

8. The method of claim 1 further comprising:
providing the user a speed dial to a destination telephone number for the advertiser paying for the advertisement.

9. The method of claim 1 wherein the advertisement includes a hyperlink to data relating to the advertisement.

10. The method of claim 9 wherein the data comprise a coupon.

11. The method of claim 9 wherein the data comprise a map.

12. The method of claim 1 wherein the advertisement is selected according to a behavioral information compiled on the user.

13. A method of providing advertisements to telephone users, the method comprising:
grouping a plurality of telephone numbers into a plurality of categories, each of the categories having a plurality of corresponding advertisements, each of the plurality of advertisements being ranked based on an amount paid by an associated advertiser;
detecting an interest by a user in a telephone number in a category in the plurality of categories; and
providing the user a highest ranked advertisement corresponding to the category.

14. The method of claim 13 wherein advertisers bid to obtain a ranking in the category.

15. The method of claim 13 wherein the advertisement is delivered to a mobile phone employed by the user.

16. The method of claim 13 wherein the advertisement includes a hyperlink to data relating to the advertisement.

17. The method of claim 13 wherein the data comprises a map.

18. A method of receiving advertisements in a telephone, the method comprising:
making a telephone call to a telephone number; and
receiving an advertisement based on the telephone number.

19. The method of claim 18 wherein the telephone number and the advertisement belong to different businesses providing similar products.

20. The method of claim 18 wherein the advertisement is received before the call to the telephone number is completed.

21. The method of claim 18 wherein the advertisement is displayed on a display of a telephone employed by a user to make the call.
